(19) United States
(12) Patent Application Publication
(10) Pub. No.: US 2025/0184230 A1
(43) Pub. Date: Jun. 5, 2025

(54) TRAFFIC PREDICTION DEVICE, TRAFFIC PREDICTION METHOD, AND PROGRAM

(71) Applicant: NIPPON TELEGRAPH AND TELEPHONE CORPORATION, Tokyo (JP)

(72) Inventors: Erina TAKESHITA, Tokyo (JP); Tomoya KOSUGI, Tokyo (JP); Shinichi YOSHIHARA, Tokyo (JP)

(73) Assignee: NIPPON TELEGRAPH AND TELEPHONE CORPORATION, Tokyo (JP)

(21) Appl. No.: 18/837,563

(22) PCT Filed: Feb. 14, 2022
(86) PCT No.: PCT/JP2022/005757

§ 371 Date: Aug. 9, 2024

(51) Int. Cl. H04L 41/147; H04L 41/16

(52) U.S. Cl. CPC H04L 41/147; H04L 41/16

(57) ABSTRACT

A traffic prediction device (1) according to the present invention includes a data acquisition unit (11) that acquires a requirement of the line and traffic data in the line, a prediction data generation unit (12) that generates a first feature amount corresponding to a traffic variation due to a change in a requirement of the line based on the acquired requirement, and generates a second feature amount based on traffic statistics representing a feature of the traffic variation for each time based on the acquired traffic data; and a prediction function unit (13) that predicts a future traffic flow rate from the first feature amount and the second feature amount.

### TECHNICAL FIELD

The present disclosure relates to a traffic prediction device, a traffic prediction method, and a program in a network in which a plurality of communication lines are accommodated in a link between communication devices.

### BACKGROUND ART

Conventionally, in traffic prediction, prediction is performed by Reccurent Neural Network (RNN) or prediction from requirements of line by a machine learning model. The requirements of the line are defined as a bandwidth upper limit value (hereinafter, referred to as a contract bandwidth) and the like.

FIG. 10 is a diagram illustrating a configuration example of a conventional network system according to a traffic prediction device. A link arranged between two communication devices accommodates a plurality of user communication lines (hereinafter, referred to as lines). Each line has requirements, and a contract bandwidth is set according to the requirement. Physical interfaces provided in the respective communication devices measure traffic data such as traffic flow rates. The measured traffic data is stored in a traffic database. The traffic prediction device includes a bandwidth prediction function unit, and the bandwidth prediction function unit predicts a future traffic flow rate flowing through each link based on information stored in a traffic database and a line database.

FIG. 11 is a diagram illustrating traffic prediction using a conventional RNN. The bandwidth prediction function unit predicts a future traffic flow rate from past traffic data using a time-series prediction model (long short term memory (LSTM) or the like) by an RNN.

FIG. 12 is a diagram illustrating traffic prediction based on a requirement by a conventional machine learning model. The bandwidth prediction function unit predicts a future traffic flow rate from future line data (data of a contract bandwidth or the like based on a requirement of a line) using a deep learning model (Supervied Variational AutoEncoder (SVAE) or the like).

Non Patent Literature 1 describes the evaluation of effectiveness of various RNN architectures for traffic prediction. Non Patent Literature 2 describes a bandwidth design method for calculating a required bandwidth based on traffic prediction by machine learning. In addition, Non Patent Literature 3 describes a method of predicting a statistical upper limit value of traffic.

### CITATION LIST

### Non Patent Literature

[NPL 1] R. Vinayakumar, and 2 others, “Applying deep learning approaches for network traffic prediction”, 2017 International Conference on Advances in Computing, Communications and Informatics (ICACCI), 2017
[NPL 2] Erika TAKESHITA, and 2 others, “Bandwidth design method for guaranteed bandwidth relay network based on traffic estimation using machine learning”, IEICE Conferences Archives The Institute of Electronics, Information and Communication Engineers, 2020
[NPL 3] E. Takeshita, and 2 others, “Traffic statistical upper limit prediction from flow features in network provisioning”, 2021 IEEE Global Communications Conference (GLOBECOM), 2021

### SUMMARY OF INVENTION

### Technical Problem

However, the number of lines to be accommodated or the traffic flow rate may change with time in accordance with a new addition, deletion, change of the requirements, and the like of the lines. In such a case, in the prediction by the RNN, there is a problem that the prediction value cannot follow the traffic variation accompanying the change of the requirement of the line, and an error is large. In addition, in the prediction from the requirements by a machine learning model, since the traffic flow rate is predicted for each set of requirements of the line, it is impossible to follow the traffic variations over time, or the prediction accuracy is lowered when the correlation between the requirements and the traffic flow rate is low.

The object of the present invention, which has been made in view of such circumstances, is to realize more accurate prediction of traffic flow rate based on the requirements of the line and traffic statistics.

### Solution to Problem

In order to solve the above problem, a traffic prediction device according to the present disclosure is a traffic prediction device for predicting a future traffic flow rate in a link accommodating a plurality of lines, the device including a data acquisition unit that acquires a requirement of the line and traffic data in the line, a prediction data generation unit that generates a first feature amount corresponding to a traffic variation due to a change in a requirement of the line based on the acquired requirement, and generates a second feature amount based on traffic statistics representing a feature of the traffic variation for each time based on the acquired traffic data, and a prediction function unit that predicts a future traffic flow rate from the first feature amount and the second feature amount.

In order to solve the above problem, a traffic prediction method according to the present disclosure is a traffic prediction method for predicting a future traffic flow rate in a link accommodating a plurality of lines and includes, by a traffic prediction device, a step of acquiring a requirement of the line and traffic data in the line, a step of generating a first feature amount corresponding to a traffic variation due to a change in a requirement of the line based on the acquired requirement, a step of generating a second feature amount based on traffic statistics representing a feature of traffic variation for each time based on the acquired traffic data, and a step of predicting a future traffic flow rate from the first feature amount and the second feature amount.

In order to solve the above problem, a program according to the present disclosure causes a computer to function as the above traffic prediction device.

### Advantageous Effects of Invention

According to the present disclosure, it is possible to achieve more accurate prediction of traffic flow rate based on requirements and traffic statistics.

### BRIEF DESCRIPTION OF DRAWINGS

FIG. 1 is a block diagram illustrating a configuration example of a traffic prediction device according to a first embodiment.

FIG. 2 is a diagram illustrating an example of a structure of prediction data generated by a prediction data generation unit.

FIG. 3 is a diagram illustrating an example of learning data used by a prediction function unit to learn a model used for predicting traffic flow rate.

FIG. 4 is a flowchart illustrating an example of a traffic prediction method executed by the traffic prediction device according to the first embodiment.

FIG. 5 is a table illustrating a quantitative effect of the traffic prediction device according to the first embodiment.

FIG. 6 is a block diagram illustrating a configuration example of a traffic prediction device according to a second embodiment.

FIG. 7 is a flow chart illustrating an example of a traffic prediction method performed by the traffic prediction device according to the second embodiment.

FIG. 8 is a diagram illustrating an example of input data used to generate prediction data.

FIG. 9 is a block diagram illustrating a schematic configuration of a computer serving as the traffic prediction device.

FIG. 10 is a block diagram illustrating a configuration example of a conventional network system.

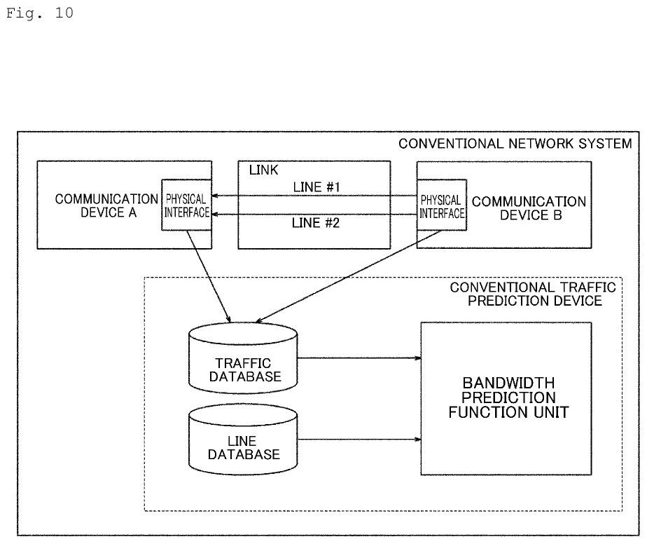

FIG. 11 is a diagram illustrating traffic prediction by conventional RNN.

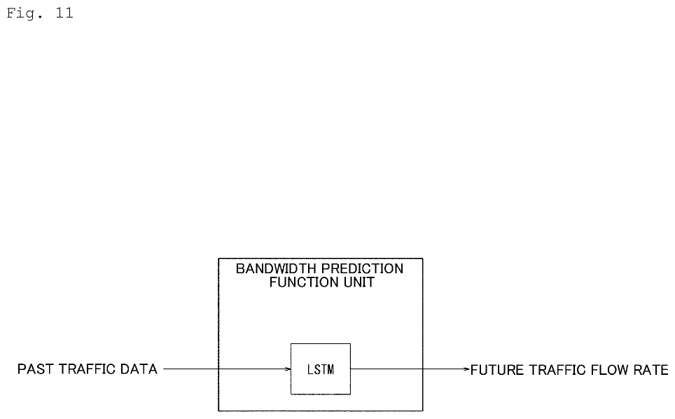

FIG. 12 is a diagram illustrating traffic prediction based on a conventional machine learning model.

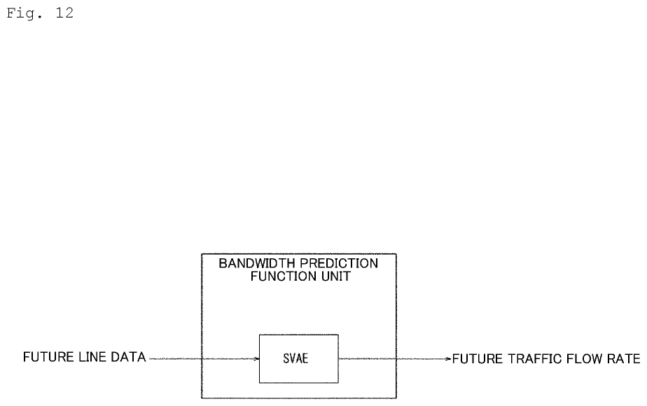

### DESCRIPTION OF EMBODIMENTS

Hereinafter, embodiments according to the present disclosure will be described in detail with reference to the drawings.

### First Embodiment

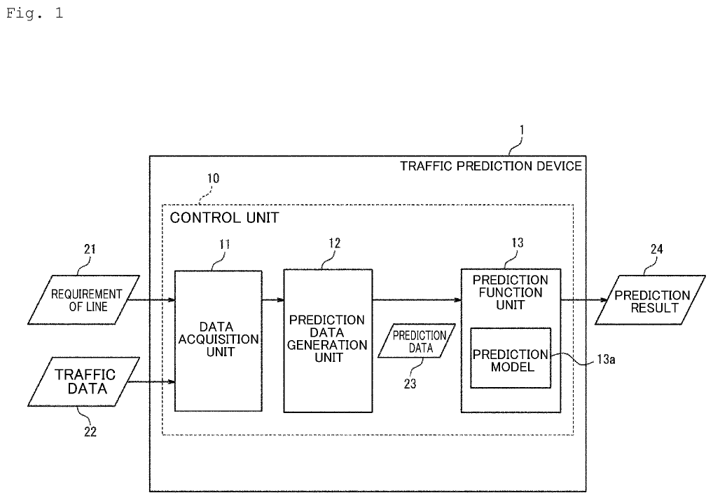

FIG. 1 is a block diagram illustrating a configuration example of a traffic prediction device 1 according to a first embodiment. The traffic prediction device 1 according to the first embodiment will be described below. As illustrated in FIG. 1, the traffic prediction device 1 includes a data acquisition unit 11, a prediction data generation unit 12, and a prediction function unit 13. The traffic prediction device 1 predicts a future traffic flow rate in a link accommodating a plurality of lines.

The data acquisition unit 11, the prediction data generation unit 12, and the prediction function unit 13 constitute a control unit 10 (controller 10). The control unit 10 (controller 10) may be configured of dedicated hardware such as an application specific integrated circuit (ASIC) or a field-programmable gate array (FPGA), may be configured of a processor, or may be configured by including these devices.

The data acquisition unit 11 acquires a requirement 21 of a line changing for each arbitrary period and traffic data 22 in the line. The data acquisition unit 11 transmits the acquired requirement 21 and the traffic data 22 to the prediction data generation unit 12.

The prediction data generation unit 12 generates a feature amount 23a (hereinafter, referred to as the first feature amount 23a) corresponding to traffic variations due to changes in requirements of a line based on the requirements of a line acquired by the data acquisition unit 11. Furthermore, the prediction data generation unit 12 generates a feature amount 23b (hereinafter, referred to as the second feature amount 23b) based on traffic statistics representing characteristics of traffic variations for each time based on the traffic data 22 acquired by the data acquisition unit 11. The prediction data generation unit 12 transmits prediction data 23 configured of the first feature amount 23a and the second feature amount 23b to the prediction function unit 13.

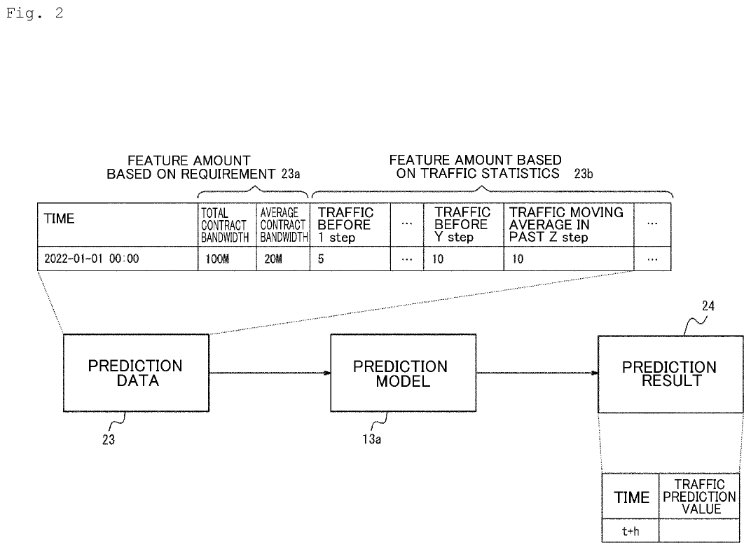

FIG. 2 is a diagram illustrating an example of the structure of the prediction data 23 generated by the prediction data generation unit 12. As illustrated in FIG. 2, the prediction data generation unit 12 generates the prediction data 23 including the first feature amount 23a and the second feature amount 23b. The first feature amount 23a is a feature amount based on a requirement of a line such as a total contract bandwidth and an average contract bandwidth. The first feature amount 23a changes every arbitrary period (for example, one day), but the traffic flow rate changes greatly with the change. The second feature amount 23b is a feature amount based on traffic statistics for each time. The second feature amount 23b is, for example, a traffic flow rate before several steps (1, 2, . . . , Y steps), a traffic moving average between past Z steps, and the like. The traffic moving average of the traffic before 1 step, . . . , the traffic before a Y step, and a traffic between past Z steps is an example of traffic statistics representing characteristics of traffic variation for each time. Here, the step indicates the time interval of measurement. For example, assuming that measurement is performed at 5 minutes intervals, 1 step represents 00:05 (HH:MM), 2 steps represent 00:10, and 3 steps represent 00:15. The traffic flow rate before several steps (before 1, 2, . . . , and Y steps) represents the traffic flow rate at each measurement time. For example, when the present time is defined as t steps, the traffic flow rate at a step t-1, the traffic flow rate at a step t-2, and the traffic flow rate at step t-Y are shown. The traffic moving average between the past Z steps represents an average value of traffic flow rates in the past measurement period. For example, assuming that the present time is a t step, (Traffic flow rate of step t-1+traffic flow rate of step t-2+ . . . +traffic flow rate of step t-Z)/Z is estimated.

Any numerical values can be applied to Y and Z illustrated in FIG. 2. Examples of the method of determining the values of Y and Z include a method to experimentally explore and determine prediction accuracy as an evaluation index and a method of determining according to the second embodiment described later. In addition, various statistics can be employed as the traffic statistics, such as the variations between the current traffic flow rate and the past traffic flow rate at each point, and a weighted moving average in addition to the traffic flow rate before several steps (before 1, 2, . . . , and Y steps) and the traffic moving average between the past Z steps.

Referring to FIG. 1 again, the prediction function unit 13 predicts the future traffic flow rate 24 (hereinafter, also referred to as prediction result 24) from the first feature amount 23a and the second feature amount 23b. The prediction function unit 13 receives the prediction data 23 composed of the first feature amount 23a and the second feature amount 23b transmitted from the prediction data generation unit 12. The prediction function unit 13 inputs the received prediction data 23 to a prediction model 13a for predicting a future traffic flow rate based on the first feature amount 23a and the second feature amount 23b, and predicts the future traffic flow rate. As the prediction model 13a, the deep learning model SVAE described above, the machine learning model LightGBM, TabNet or the like can be adopted.

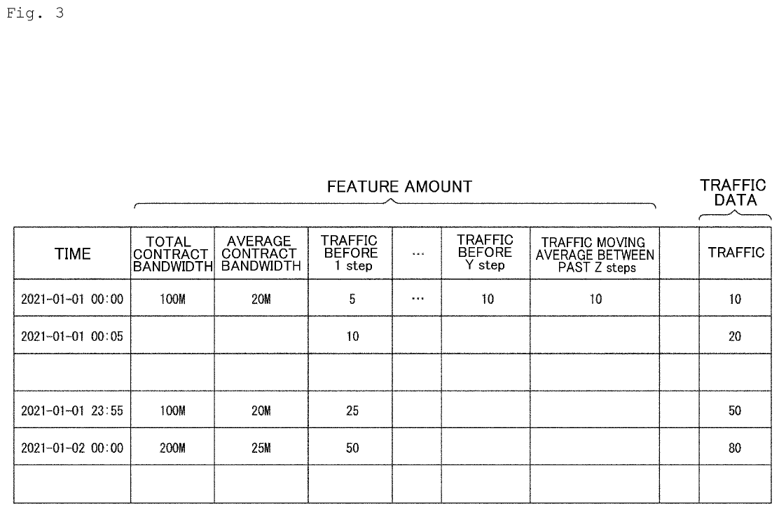

FIG. 3 is a diagram illustrating an example of learning data for learning a model used by the prediction function unit 13 for predicting the traffic flow rate. The prediction model 13a learns learning data including the first feature amount 23a, the second feature amount 23b and traffic at predetermined time intervals as illustrated in FIG. 3, thus, it is possible to prepare the same. As illustrated in FIG. 3, in the learning data, data indicating a total contract bandwidth, an average contract bandwidth, a traffic moving average of the traffic before 1 step, . . . , the traffic before the Y step, and the traffic between the past Z steps, and the traffic at each predetermined time interval (5 minute intervals in FIG. 3) are input in the learning data. The total contract bandwidth and the average contract bandwidth are examples of the requirement 21. Assuming that the total contract bandwidth and average contract bandwidth change on a daily basis, rows for the same day will have the same value. The traffic data 22 (traffic flow rate) measured at every time and moving average thereof are input to the traffic statistics illustrated in FIG. 3. The traffic statistics for each time are generated from the traffic data in the column at the right end. The requirement 21 changes every arbitrary period, but a traffic flow rate equal to or less than the contract bandwidth is generated within the period of the requirement 21. For example, in a case where the requirement 21 changes every day, the traffic flow rate may greatly vary with the change of the contract bandwidth of the requirement 21.

The prediction function unit 13 predicts the traffic flow rate of n (n is an arbitrary natural number) steps ahead of the time t. However, since the accuracy decreases as n increases, it is preferable that n be within 10.

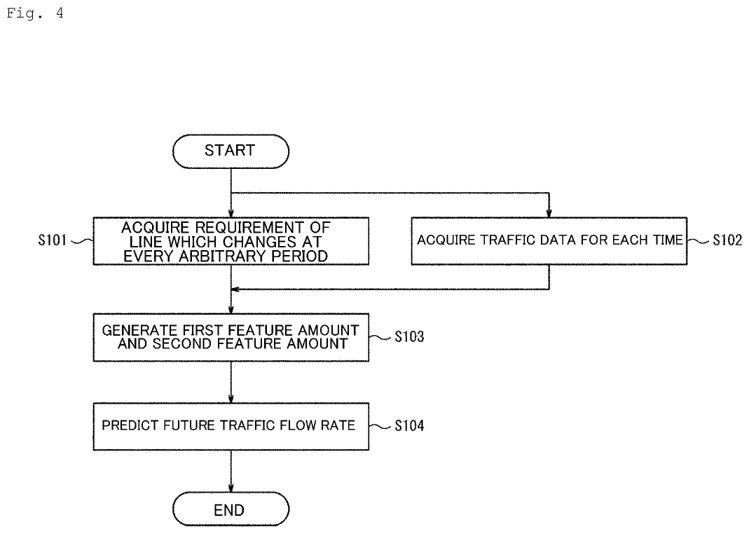

FIG. 4 is a flowchart illustrating an example of a traffic prediction method executed by the traffic prediction device 1 according to the first embodiment.

In Step S101, the data acquisition unit 11 acquires a requirement 21 of a line changing for each arbitrary period.

In Step S102, the data acquisition unit 11 acquires the traffic data 22 for generating traffic statistics representing features of traffic variation for each time. The processing of Step S101 and the processing of Step S102 may be performed in parallel as illustrated in FIG. 4, or either one of the processing may be performed first and the other processing may be performed later.

In Step S103, the prediction data generation unit 12 generates the first feature amount 23a and the second feature amount 23b.

In Step S104, the prediction function unit 13 predicts the future traffic flow rate 24 from the first feature amount 23a and the second feature amount 23b.

In the conventional traffic prediction by SVAE, since the input data is the feature amount based on the requirement, the prediction content becomes the traffic average value for each requirement. Therefore, in the case of data having a low correlation between the requirement and the traffic flow rate, there is a problem that an error between the prediction result and the actual traffic flow rate is large. In addition, the SVAE cannot predict each time interval. In addition, in the traffic prediction by LSTM, which is a conventional technique, for example, since the traffic flow rate in the future (for example, 10 steps ahead) is predicted from past traffic data, it cannot cope with a large traffic variation due to a change (line addition, bandwidth upper limit value, or the like) due to a requirement.

However, according to the traffic prediction device 1 according to the present embodiment, since the traffic flow rate is predicted based on both the requirement and the traffic statistic, the problems of the conventional technology described above can be solved as follows, and the prediction of the traffic flow rate with high accuracy can be realized. The prediction of the traffic flow rate with high accuracy is the prediction of the traffic flow rate with high accuracy corresponding to the traffic variation due to the change of the requirement and the traffic variation for each time due to the traffic statistic.

First, according to the traffic prediction device 1 according to the present embodiment, since prediction is performed based on a requirement, even in a case where the traffic variation accompanying a change in a contract bandwidth (line addition, change in a bandwidth upper limit value or the like) is large, the traffic variation can be coped with by prediction using the feature amount (first feature amount 23a) based on the requirement, and the prediction of the traffic flow rate with high accuracy can be realized.

Secondly, according to the traffic prediction device 1 according to the present embodiment, even in a case where the correlation between the requirement and the traffic statistic is low, it is possible to cope with the traffic variation due to the change of the requirement by the prediction using the traffic statistic (the second feature amount 23b), and it is possible to realize the prediction of the traffic flow rate with high accuracy.

Third, according to the traffic prediction device 1 according to the present embodiment, since the prediction is performed based on the traffic statistics, it is possible to cope with traffic variations at every time interval. For example, although the SVAE as the prior art described above can set only one value every day in order to calculate a prediction value for a requirement, according to the traffic prediction device 1, it is possible to calculate predicted values for each time interval. Therefore, it is also possible to cope with small-scale traffic variations for each time interval.

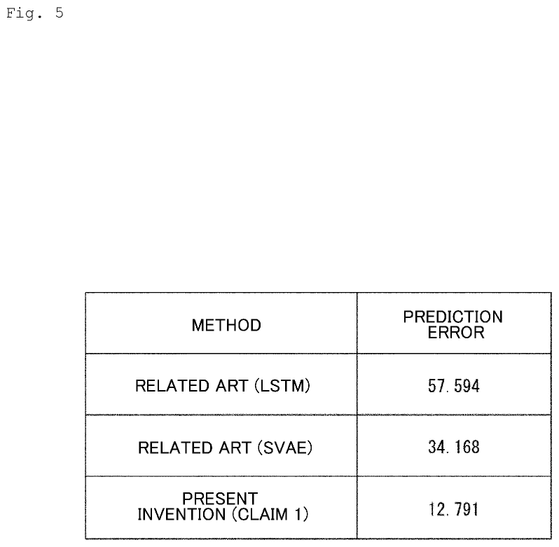

FIG. 5 is a diagram illustrating a quantitative effect of the traffic prediction device 1 according to the first embodiment. In FIG. 5, the prediction error by the conventional method is compared with the prediction error by the traffic prediction device 1. Here, the prediction error is a root mean square error (RMSE) between the actual measurement value and the prediction value. As illustrated in FIG. 5, the prediction error by the traffic prediction device 1 according to the present embodiment is 12.791, which is better data than the prediction error using LSTM according to the conventional technology of 57.594 and the prediction error using SVAE of 34.168.

### Second Embodiment

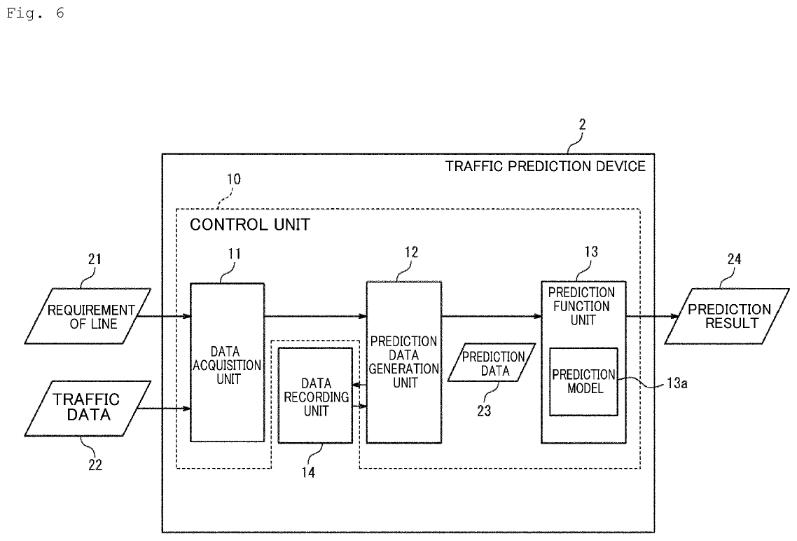

FIG. 6 is a block diagram illustrating a configuration example of a traffic prediction device 2 according to a second embodiment. As illustrated in FIG. 6, the traffic prediction device 2 includes the data acquisition unit 11, the prediction data generation unit 12, the prediction function unit 13, and a data recording unit 14. The traffic prediction device 2 predicts a future traffic flow rate in a link accommodating a plurality of lines. The traffic prediction device 2 according to the present embodiment differs from the traffic prediction device 1 according to the first embodiment in that it further includes the data recording unit 14. The same configurations as those of the first embodiment are denoted by the same reference numerals as those of the first embodiment and description thereof will be appropriately omitted.

The data acquisition unit 11, the prediction data generation unit 12, and the prediction function unit 13 configure the control unit 10 (controller 10). The control unit 10 (controller 10) may be configured by dedicated hardware such as an ASIC or an FPGA, or may be configured by a processor, or may be configured by including both.

The prediction data generation unit 12 may predict a period of traffic variation based on the past traffic statistic recorded in the data recording unit 14, and generate the second feature amount 23b based on the traffic statistic in a period corresponding to the predicted period. The prediction data generation unit 12 sequentially transmits the generated traffic statistics to the data recording unit 14 and records them. The prediction data generation unit 12 can extract a useful traffic statistic from various past traffic statistics recorded in the data recording unit 14 and generate a traffic statistic in which a cycle of traffic variation is predicted.

The data recording unit 14 sequentially stores the traffic statistic transmitted from the prediction data generation unit 12. The data recording unit 14 transmits the requested past traffic statistics to the prediction data generation unit 12 in response to the request of the prediction data generation unit 12.

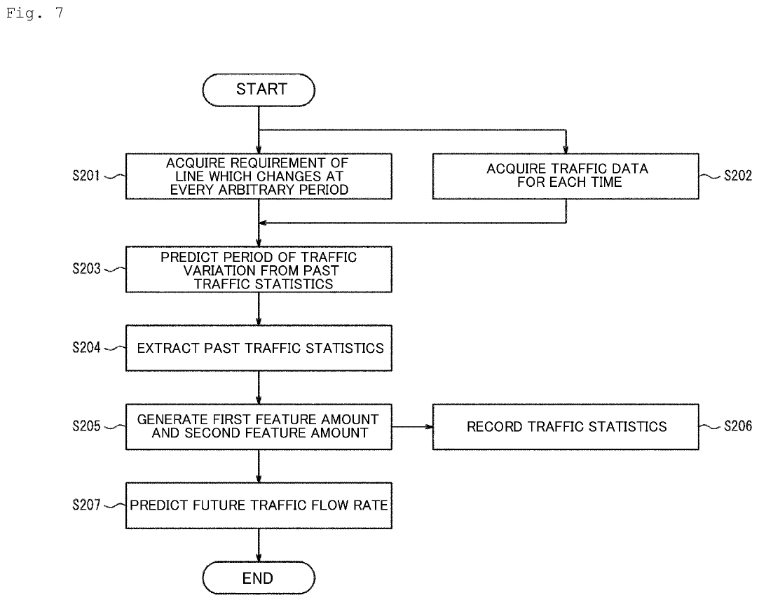

FIG. 7 is a flowchart illustrating an example of a traffic prediction method which is executed by the traffic prediction device according to the second embodiment.

In Step S201, the data acquisition unit 11 acquires the requirement 21 of the line changing for each arbitrary period.

In Step S202, the traffic data 22 for generating the traffic statistics representing features of the traffic variation for each time is acquired. The processing of Step S201 and the processing of Step S202 may be performed in parallel as illustrated in FIG. 7, or any one of the processing may be performed first and the other processing may be performed later.

In Step S203, the prediction data generation unit 12 predicts a period of traffic variation from past traffic statistics.

In Step S204, the prediction data generation unit 12 extracts the past traffic feature amount recorded in the data recording unit 14.

In Step S205, the prediction data generation unit 12 generates the first feature amount 23a and the second feature amount 23b.

In Step S206, the prediction data generation unit 12 records the generated traffic statistic in the data recording unit 14.

In Step S207, the prediction function unit 13 predicts the future traffic flow rate 24 from the first feature amount 23a and the second feature amount 23b.

The traffic statistics according to the present embodiment may be various traffic statistics such as traffic statistics at each past time point, variations between the current traffic and the past traffic at each time point, weighted moving average, and the like. It is determined what kind of feature amount should be extracted from among these various statistical quantities. In the following examples, there are examples of setting the number of steps of past traffic and the number of days of moving average. Similarly, the traffic statistics according to the present embodiment can be created using a determination based on whether the conditions are the same requirement or a determination based on general statistical processing.

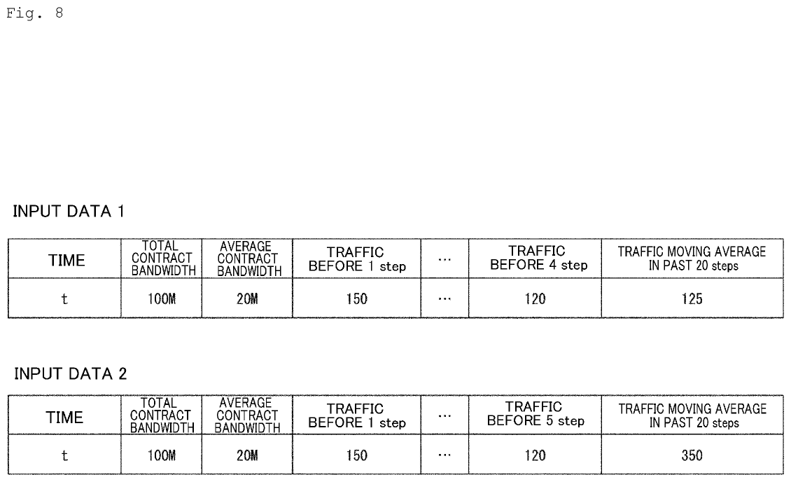

According to the traffic prediction device 2 according to the present embodiment, as shown in the following four examples, it is possible to realize highly accurate prediction of the traffic flow rate. FIG. 8 is a diagram illustrating an example of input data used to generate prediction data.

### Example of Setting the Number of Days of Moving Average-1

For example, at the prediction point of time indicated by input data 1 in FIG. 8, a moving average of a period shorter than the application period (one day in the present example) of the same requirement is adopted. By adopting the moving average in the short period, prediction accuracy is improved by performing prediction from the moving average not including the traffic flow rate of different requirements different in behavior from the prediction point of time.

### Example of Setting the Number of Days of Moving Average-2

The moving average is calculated in a plurality of periods, and whether each moving average is an outlier is determined by statistical processing, thereby adopting a moving average value after the moving average of the latest outlier. Statistical tests used to determine outliers include common methods such as the Smrinov-Grubbs test. A period of traffic variation other than variation due to change of the requirement is predicted, and prediction is performed from a moving average not including a traffic flow rate different in behavior from a prediction point of time, thereby improving prediction accuracy.

### Example of Setting the Number of Steps of Past Traffics-1

For example, at the prediction point of time shown in the input data 2 of FIG. 8, the traffic flow rate within the application period of the same requirement is adopted. By adopting such a traffic flow rate, prediction is performed from past traffic flow rates which do not include traffic flow rates of different requirements different in behavior from a prediction time point, thereby improving prediction accuracy.

### Example of Setting the Number of Steps of Past Traffics-2

By determining whether each traffic flow rate is an outlier by statistical processing in the past traffic flow rate for an arbitrary period, the traffic flow rate after the most recent outlier is adopted as the traffic flow rate several steps before as the predicted input data. A period of traffic variation other than variation due to change of the requirement is predicted, and prediction is performed from a past traffic flow rate not including a traffic flow rate different in behavior from a prediction time point, thereby improving prediction accuracy.

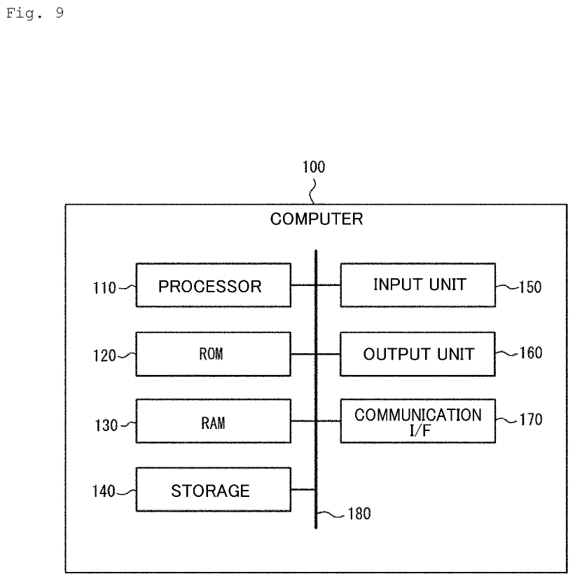

It is also possible to use a computer capable of executing program instructions to function as the above traffic prediction devices 1 and 2. FIG. 9 is a block diagram illustrating a schematic configuration of a computer serving as the traffic prediction device. Here, the computers functioning as the traffic prediction devices 1 and 2 may be general-purpose computers, special-purpose computers, workstations, personal computers (PCs), electronic notepads, or the like. The program instructions may be program code, code segments, and the like for executing the required tasks.

As illustrated in FIG. 9, the computer 100 includes a processor 110, a read only memory (ROM) 120, a random access memory (RAM) 130, and a storage 140 as a storage unit, an input unit 150, an output unit 160, and a communication interface (I/F) 170. The components are connected to each other via a bus 180 such that they can communicate.

The ROM 120 stores various programs and various data. The RAM 130 temporarily stores programs or data as a work region. The storage 140 is configured of a hard disk drive (HDD) or a solid state drive (SSD) and stores various programs including an operating system and various data. In the present disclosure, the ROM 120 or the storage 140 stores a program according to the present disclosure.

The processor 110 is specifically a central processing unit (CPU), a micro processing unit (MPU), a graphics processing unit (GPU), a digital signal processor (DSP), a system on a chip (SoC), or the like and may be composed of multiple processors of the same type or different types. The processor 110 reads a program from the ROM 120 or the storage 140 and executes the program using the RAM 130 as a work area to perform control of each of the aforementioned components and various types of arithmetic processing. At least a part of such processing may be realized by hardware.

The program may be recorded on a recording medium readable by the traffic prediction devices 1 and 2. With the use of such a recording medium, it can be installed on traffic prediction devices 1 and 2. Here, the recording medium on which the program is recorded may be a non-transitory recording medium. The non-transitory recording medium is not particularly limited, but may be, for example, a CD-ROM, a DVD-ROM, a universal serial bus (USB) memory, or the like. Also, this program may be downloaded from an external device over a network.

The following additional remarks are disclosed in relation to the embodiments described above.

### Supplement Item 1

A traffic prediction device for predicting a future traffic flow rate in a link accommodating a plurality of lines, the device including
a controller that acquires a requirement of the line and traffic data in the line, generates a first feature amount corresponding to a traffic variation due to a change in a requirement of the line based on the acquired requirement, and generates a second feature amount based on traffic statistics representing a feature of the traffic variation for each time based on the acquired traffic data, and predicts a future traffic flow rate from the first feature amount and the second feature amount.

### Supplement Item 2

The traffic prediction device according to Supplement Item 1 further includes a memory that sequentially records the traffic statistics, in which
the controller predicts a period of traffic variation based on a past traffic statistic recorded in the memory, and generates the second feature amount based on a traffic statistic in a period corresponding to the predicted period.

### Supplement Item 3

A traffic prediction method for predicting a future traffic flow rate in a link accommodating a plurality of lines, the method including
by a traffic prediction device, a step of acquiring a requirement of the line and traffic data in the line, a step of generating a first feature amount corresponding to a traffic variation due to a change in a requirement of the line based on the acquired requirement, a step of generating a second feature amount based on traffic statistics representing a feature of traffic variation for each time based on the acquired traffic data, and a step of predicting a future traffic flow rate from the first feature amount and the second feature amount.

### Supplement Item 4

A non-temporary storage medium storing a program executable by a computer, the non-temporary storage medium storing a program that causes the computer to function as the traffic prediction device according to Supplement Item 1 or 2.

Although the above-described embodiment has been introduced as a typical example, it is clear for a person skilled in the art that many alterations and substitutions are possible within the gist and scope of the present disclosure. Therefore, the embodiment described above should not be interpreted as limiting, and the present invention can be modified and altered in various ways without departing from the scope of the claims. For example, a plurality of configuration blocks shown in the configuration diagrams of the embodiments may be combined to one, or one configuration block may be divided.

### REFERENCE SIGNS LIST

1, 2 Traffic prediction device
10 Control unit (controller)
11 Data acquisition unit
12 Prediction data generation unit
13 Prediction function unit
13a Prediction model
14 Data recording unit (memory)
21 Requirement of line
22 Traffic data
23 Prediction data
23a First feature amount (feature amount based on requirement of line)
23b Second feature amount (feature amount based on traffic statistic)
24 Future traffic flow rate (prediction result)
100 Computer
110 Processor
120 ROM
130 RAM
140 Storage
150 Input unit
160 Output unit
170 Communication interface (I/F)
180 Bus

1. A traffic prediction device for predicting a future traffic flow rate in a link accommodating a plurality of lines, the device comprising:
a data acquisition unit that acquires a requirement of the line and traffic data in the line;
a prediction data generation unit that generates a first feature amount corresponding to a traffic variation due to a change in a requirement of the line based on the acquired requirement, and generates a second feature amount based on traffic statistics representing a feature of the traffic variation for each time based on the acquired traffic data; and
a prediction function unit that predicts a future traffic flow rate from the first feature amount and the second feature amount.

2. The traffic prediction device according to claim 1, further comprising:
a data recording unit that sequentially records the traffic statistics, wherein
the prediction data generation unit predicts a period of traffic variation based on a past traffic statistic recorded in the data recording unit, and generates the second feature amount based on a traffic statistic in a period corresponding to the predicted period.

3. A traffic prediction method for predicting a future traffic flow rate in a link accommodating a plurality of lines, the method comprising:
a traffic prediction device performs,
acquiring a requirement of the line and traffic data in the line;
generating a first feature amount corresponding to a traffic variation due to a change in a requirement of the line based on the acquired requirement;
generating a second feature amount based on traffic statistics representing a feature of traffic variation for each time based on the acquired traffic data; and
predicting a future traffic flow rate from the first feature amount and the second feature amount.

4. (canceled)

5. The traffic prediction method for predicting a future traffic flow rate in a link accommodating a plurality of lines according to claim 3, the method further comprising:
predicting a period of traffic variation based on a past traffic statistic recorded in the data recording unit, and generating the second feature amount based on a traffic statistic in a period corresponding to the predicted period.

6. A computer-readable non-transitory recording medium storing computer-executable program instructions that when executed by a processor cause a computer to execute a program generation method comprising:
acquiring a requirement of the line and traffic data in the line;
generating a first feature amount corresponding to a traffic variation due to a change in a requirement of the line based on the acquired requirement;
generating a second feature amount based on traffic statistics representing a feature of traffic variation for each time based on the acquired traffic data; and
predicting a future traffic flow rate from the first feature amount and the second feature amount.

7. The computer-readable non-transitory recording medium according to claim 6 wherein the image processing method further comprises:
predicting a period of traffic variation based on a past traffic statistic recorded in the data recording unit, and generating the second feature amount based on a traffic statistic in a period corresponding to the predicted period.
